(19) United States
(12) Patent Application Publication
(10) Pub. No.: US 2022/0408973 A1
(43) Pub. Date: Dec. 29, 2022

(54) Lockable Food Delivery Box Apparatus

(71) Applicant: David Pierre, Ocean, NJ (US)

(72) Inventor: David Pierre, Ocean, NJ (US)

(21) Appl. No.: 17/361,233

(22) Filed: Jun. 28, 2021

(51) Int. Cl. A47J 41/00; H05B 3/68; B65D 81/38; B65D 55/14; B65D 51/24; B65D 43/16; A47J 36/24; A47J 47/14; G08C 17/02; G07C 9/00

(52) U.S. Cl. CPC A47J 41/005; H05B 3/68; B65D 81/3813; B65D 55/14; B65D 51/242; B65D 43/163; A47J 36/2483; A47J 47/14; G08C 17/02; G07C 9/00896; F25D 11/003

(57) ABSTRACT

A lockable food delivery box apparatus for preventing food tampering and contamination includes an insulated box defining a storage cavity configured to store food items for delivery. A box lid is selectively engageable with an open side of the insulated box. An electronic lock is coupled to the insulated box and is in operational communication with the box lid to secure and alternatively free the box lid. The electronic lock has a transceiver configured to be in operational communication with a smartphone. A heating coil is coupled to the insulated box to raise the temperature within the storage cavity. A cooling system is coupled to the insulated box to lower the temperature within the storage cavity. A power supply is coupled within the insulated box and is in operational communication with the heating coil, the cooling system, and the electronic lock.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to food delivery boxes and more particularly pertains to a new food delivery box for preventing food tampering and contamination.

### (2) Description of Related Art Including Information Disclosed Under 37 CFR 1.97 and 1.98

The prior art relates to food delivery boxes. Existing food delivery boxes have attempted temperature control and lockable boxes exist. However, the locking mechanisms are designed for owner use and not to be opened only by the recipient. Most existing temperature control boxes are designed to either maintain food items hot or cold but are not capable of both.

### BRIEF SUMMARY OF THE INVENTION

An embodiment of the disclosure meets the needs presented above by generally comprising an insulated box defining a storage cavity configured to store food items for delivery. A box lid is selectively engageable with an open side of the insulated box. An electronic lock is coupled to the insulated box and is in operational communication with the box lid to secure and alternatively free the box lid. The electronic lock has a transceiver configured to be in operational communication with a smartphone. A heating coil is coupled to the insulated box and is configured to raise the temperature within the storage cavity. A cooling system is coupled to the insulated box and is configured to lower the temperature within the storage cavity. A power supply is coupled within the insulated box and is in operational communication with the heating coil, the cooling system, and the electronic lock.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a lockable food delivery box apparatus according to an embodiment of the disclosure.

FIG. 2 is a bottom plan view of an embodiment of the disclosure.

FIG. 3 is a rear elevation view of an embodiment of the disclosure.

FIG. 4 is a front elevation view of an embodiment of the disclosure.

FIG. 5 is a side elevation view of an embodiment of the disclosure.

FIG. 6 is a cross-sectional view of an embodiment of the disclosure along line 6-6 of FIG. 5.

### DETAILED DESCRIPTION OF THE INVENTION

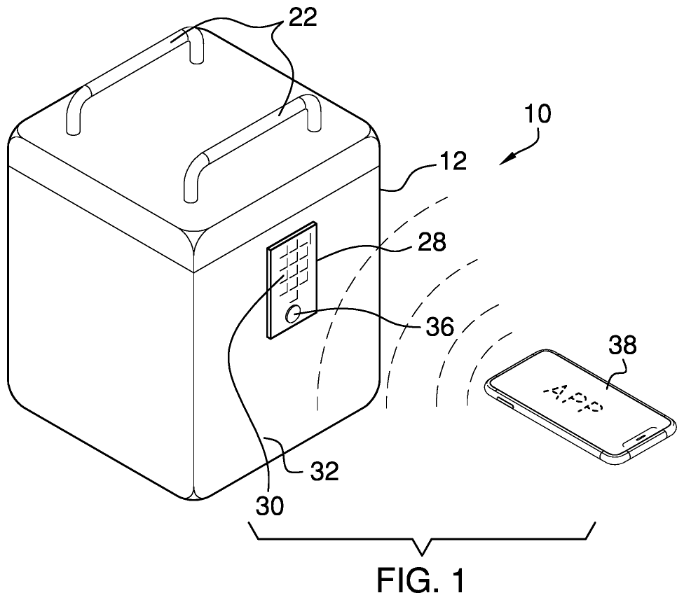

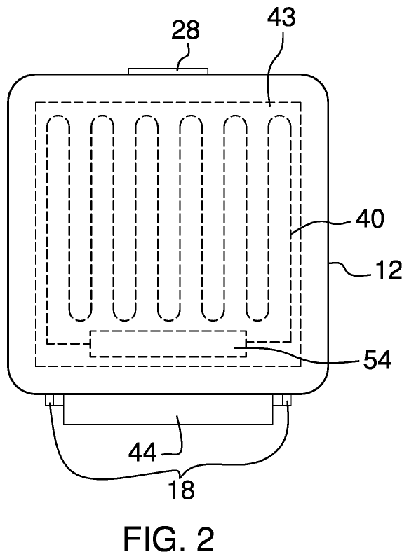

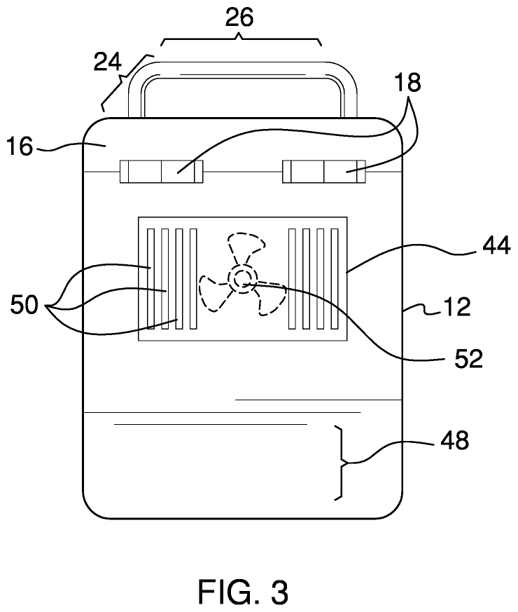

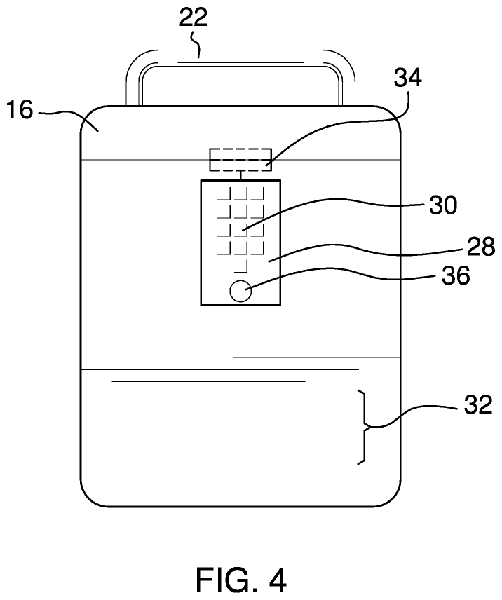

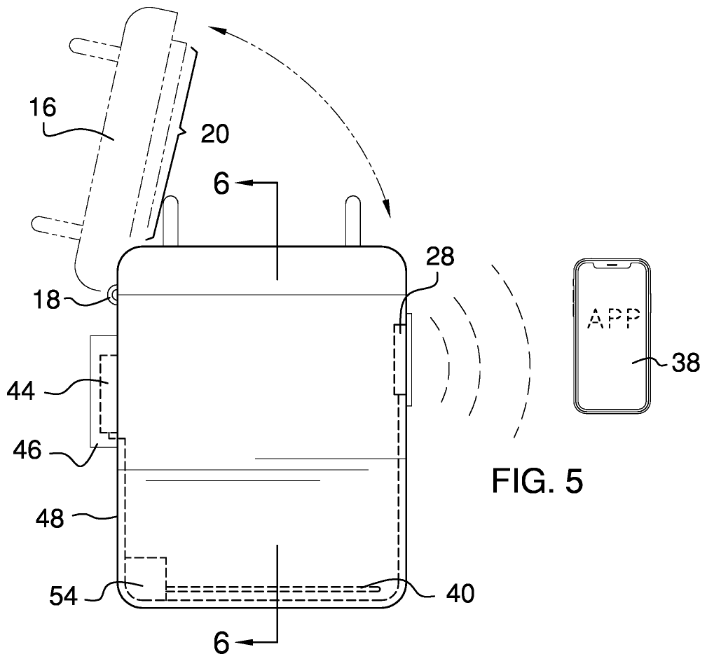

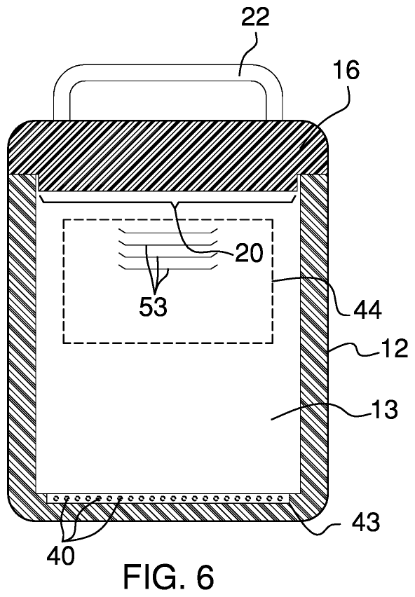

With reference now to the drawings, and in particular to FIGS. 1 through 6 thereof, a new food delivery box embodying the principles and concepts of an embodiment of the disclosure and generally designated by the reference numeral 10 will be described.

As best illustrated in FIGS. 1 through 6, the lockable food delivery box apparatus 10 generally comprises an insulated box 12 defining a storage cavity 13 configured to store food items for delivery. The insulated box 12 may be rectangular prismatic and has an open top side 14. The insulated box 12 may have rounded edges to prevent injury or damage. Each side of the insulated box 12 may be a solid insulating material or may have a hard shell filled with an insulating material. A box lid 16 is coupled to the insulated box 12. The box lid 16 may have a pair of hinges 18 coupled to the insulated box 12 to swingingly move between an open and a closed position. A protrusion portion 20 of the box lid may selectively engage the open top side 14 of the insulated box to create a snug press fit and improve insulation. There may be at least one handle 22 coupled to the box lid 16. There may be a pair of parallel handles 22 each having a pair of 90° curved elbows 24 coupled to the box lid 16 and a straight portion 26 extending therebetween.

An electronic lock 28 is coupled to the insulated box 12. The electronic lock 28 may have a keypad 30 coupled to a box front side 32 of the insulated box and a latch mechanism 34 in operational communication with the box lid 16 to secure and alternatively free the box lid 16. The electronic lock 28 has a transceiver 36 configured to be in operational communication with a smartphone 38. The latch mechanism 34 is engaged and disengaged using either the keypad 30 or the smartphone 38, allowing a restaurant or other food preparation business to lock the electronic lock 28 and send the apparatus 10 with a delivery driver who is unable to open the box lid 16. The receiving customer may then use his or her smartphone 38 to disengage the electronic lock 28 and retrieve the food items knowing they have not been tampered with. The transceiver 36 may communicate directly with the smartphone 38 with Bluetooth, Wi-Fi, or other wireless technologies, or may alternatively be web connected using cellular signal. The keypad 30 may be rectangular prismatic and protrudes from the box front side 32 proximal the open top side 14.

A heating coil 40 is coupled to the insulated box 12 to raise the temperature within the storage cavity 13. The heating coil 40 may be coupled within a box bottom side 42 of the insulated box to be most proximal the food items stored within the storage cavity 13. The box bottom side 42 may have a rectangular cavity 43 adjacent the storage cavity 13 to accommodate the heating coil 40. A cooling system 44 is coupled to the insulated box 12 to lower the temperature within the storage cavity 13. The cooling system 44 may have a rectangular prismatic cooler housing 46 coupled to a box back side 48 of the insulated box with a plurality of vertical vents 50 extending through the cooler housing 46. A fan 52 may be coupled within the cooler housing 46 to control airflow through a plurality of louvered slots 53 extending through the box back side 42.

A power supply 54 is coupled within the insulated box 12 and is in operational communication with the heating coil 40, the cooling system 44, and the electronic lock 28. The power supply 54 may be a rechargeable battery. The keypad 30 of the electronic lock may be used to control the heating coil 40 and the cooling system 44 to set a desired temperature within the storage cavity 13.

In use, the food item is placed within the storage cavity 13 and the box lid 16 is moved to the closed position. The latch mechanism 34 is then engaged with the keypad 30 and either the heating coil 40 or the cooling system 44 is activated to keep the food item at the desired temperature. Upon delivery, the recipient may then use an app on his or her smartphone 38 to disengage the latch mechanism 34 via the transceiver 36 of the electronic lock.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A lockable food delivery box apparatus comprising:
an insulated box defining a storage cavity, the insulated box being configured to store food items for delivery within the storage cavity;
a box lid coupled to the insulated box, the box lid being selectively engageable with an open side of the insulated box;
an electronic lock coupled to the insulated box, the electronic lock being in operational communication with the box lid to secure and alternatively free the box lid, the electronic lock having a transceiver configured to be in operational communication with a smartphone;
a heating coil coupled to the insulated box, the heating coil being configured to raise the temperature within the storage cavity;
a cooling system coupled to the insulated box, the cooling system being configured to lower the temperature within the storage cavity; and
a power supply coupled within the insulated box, the power supply being in operational communication with the heating coil, the cooling system, and the electronic lock.

2. The lockable food delivery box apparatus of claim 1 further comprising at least one handle coupled to the box lid.

3. The lockable food delivery box apparatus of claim 2 further comprising the at least one handle being a pair of handles.

4. The lockable food delivery box apparatus of claim 2 further comprising each handle having a pair of 90° curved elbows and a straight portion extending therebetween.

5. The lockable food delivery box apparatus of claim 1 further comprising the insulated box being rectangular prismatic and having an open top side, the box lid having a protrusion portion selectively engaging the open top side.

6. The lockable food delivery box apparatus of claim 1 further comprising the box lid having a pair of hinges coupled to the insulated box.

7. The lockable food delivery box apparatus of claim 1 further comprising the heating coil being coupled within a box bottom side of the insulated box.

8. The lockable food delivery box apparatus of claim 1 further comprising the electronic lock having a keypad coupled to a box front side of the insulated box.

9. A lockable food delivery box apparatus comprising:
an insulated box defining a storage cavity, the insulated box being configured to store food items for delivery within the storage cavity, the insulated box being rectangular prismatic and having an open top side;
a box lid coupled to the insulated box, the box lid having a pair of hinges coupled to the insulated box and a protrusion portion selectively engaging the open top side of the insulated box;
at least one handle coupled to the box lid, each handle having a pair of 90° curved elbows and a straight portion extending therebetween;
an electronic lock coupled to the insulated box, the electronic lock having a keypad coupled to a box front side of the insulated box and a latch mechanism in operational communication with the box lid to secure and alternatively free the box lid, the electronic lock having a transceiver configured to be in operational communication with a smartphone;
a heating coil coupled to the insulated box, the heating coil being coupled within a box bottom side of the insulated box and configured to raise the temperature within the storage cavity;
a cooling system coupled to the insulated box, the cooling system being configured to lower the temperature within the storage cavity; and
a power supply coupled within the insulated box, the power supply being in operational communication with the heating coil, the cooling system, and the electronic lock.
